(19) United States
(12) Patent Application Publication
(10) Pub. No.: US 2005/0288906 A1
(43) Pub. Date: Dec. 29, 2005

(54) Spectroscopic pharmacy verification and inspection system

(76) Inventors: James K. Drennen III, Mars, PA (US); Carl A. Anderson, Cranberry Township, PA (US)

Correspondence Address: Craig G. Cochenour, Esq.;Buchanan Ingersoll PC, One Oxford Centre, 20th Floor, 301 Grant Street, Pittsburgh, PA, 15219, US

(21) Appl. No.: 10/879,388

(22) Filed: Jun. 29, 2004

(51) Int. Cl. G06F 15/00

(52) U.S. Cl. 702/189

(57) ABSTRACT

An apparatus for verifying the identity, quality and/or quantity of each product unit, such as, for example, a dosage unit of a pharmaceutical dispensed into a container, which includes an analyzing device, such as a spectrometer, and a control device for controlling the analyzing device. The invention is integrated with background art automated counting and dispensing systems such that product units may be individually analyzed and verified prior to being placed into the container.

### FIELD OF THE INVENTION

The present invention pertains to spectral data analysis and more particularly to the identification and quality verification of various products, particularly pharmaceuticals, using a spectrometer.

### BACKGROUND OF THE INVENTION

There is an ongoing and predicted long-term shortage of licensed pharmacists. Due to the increasing age of the population and the ever-increasing number of prescription medicines available, the demand for prescription drugs is growing at a rate that will far exceed the capacity and numbers of licensed pharmacists. According to the National Association of Chain Drug Stores, the number of prescriptions filled between 2000 and 2005 will increase by 41%, while the number of retail pharmacists will only increase by 4.5%. The net impact of this imbalance is that pharmacists are increasingly spending more time doing clerical and administrative tasks such as verifying filled prescriptions and checking data entry done by pharmacy technicians. Since the capacity of any one pharmacist if fixed, the output of a pharmacy has become constrained. Consequently, the labor and total cost per prescription continues to rise.

Due to these increased demands on a pharmacist's time, and the resulting increased reliance on technicians and other non-professional staff to fill prescriptions, there is an increased chance for prescription error. While these errors may take many forms, the likelihood of a dangerous or life threatening “adverse drug event” increases proportionally with the increased chance of prescription fill error. Several studies have shown that prescription error rates are consistently in the 2% to 7% range, with a 4% error are often cited as a reliable average. The number of deaths due to medication errors is estimated to exceed 7000 per year in the United States alone. This number does not include non-fatal conditions from drugs that also result in some form of trauma or injury. The resulting litigation costs associated with these prescription fill errors has also dramatically increased. Available information shows that settlements from such lawsuits average $500,000 per incident.

A typical pharmacy utilizes an automated counting and dispensing system (one system in common use is sometimes referred to as a Baker unit) to fill prescription vials with dosage units of the desired medication, especially for larger volume pharmaceuticals. It is also common to find a computerized inventory and authentication system in use, which, if electronically tied to the automated dispensing system, will also provide for the control thereof. However, existing pharmacy filling systems and procedures still require that a human operator, whether that operator is a technician or a licensed pharmacist, verify visually whether the drug that is delivered to the customer is correct. Thus, the human factor is the weak link in the chain that contributes to the majority of prescription fill errors.

Existing visual verification techniques rely on comparing an electronic image of the prescribed medication (i.e. a picture of the prescribed medication retrieved from a data library) with the actual medication that is dispensed for the patient. Other systems and procedures rely on comparing the dispensed medication with that in the original manufacturer's supply container, or comparing an electronic image of the filled prescription with an electronic image of the prescribed medication retrieved from a data library. Each of these existing verification systems presents similar problems.

These known verification methods assume that all drugs are visually distinct. This assumption causes many problems because many drugs are not, in fact, visually distinct and, in other cases the visual differences between drugs is very subtle. For instance, manufacturers are rapidly running out of unique shapes, colors and sizes for their solid dosage from products. To further complicate the problem, generic drug manufacturers are using shapes, colors and sizes that are different than that of the original manufacturer.

Additionally, each of the known manual verification techniques also requires that the pharmacist spend a significant portion of the day performing administrative or clerical tasks and allows less time for patient consultation and other professional pharmacist activities. This fact in itself is considered one of the leading reasons for the decline in graduation rate of professional pharmacists. The ability to allow the pharmacist to focus more on patient counseling rather than clerical and administrative duties is widely seen as an important promotional effort to meet the increasing demand for professionally trained pharmacists.

Solid dosage pharmaceuticals (e.g. tablets, capsules, and lozenges) have a unique combination of chemical composition and physical properties. These properties result in a unique chemical signature which is discernable upon suitable analysis. Pharmaceuticals with varying dosage levels of the same active ingredient have unique chemical signatures as well. Even slight variations in the active ingredients, excipients, or manufacturing methods will produce a unique chemical signature. In that regard, most pharmaceuticals can be identified accurately by the use of an appropriate analytical technique. This same methodology may be applied to other forms of medication (e.g. liquids, creams, and powders).

While there are many appropriate analytical techniques for determining the unique chemical signature of a sample, near-infrared (NIR) spectroscopy is one of the most rapidly growing methodologies in use for product analysis and quality control. For instance, NIR spectroscopy is being increasingly used as an inspection method during the packaging process of pharmaceuticals or food products. More and more often, this technique is augmenting or even replacing previously relied-upon visual inspection methodologies or laboratory-based analytical techniques. For example, a system that utilizes a combined visible and NIR spectroscopy inspection system can be used to inspect a pharmaceutical product for, among other things, chemical composition, color, and dosage level.

Particularly with solid dosage pharmaceutical products, while a group or package of products may look identical in the visible portion of the spectrum each product has a unique chemical signature in the near-infrared wavelength range (800-2500 nm). What is unique about these NIR spectroscopic inspection and verification systems is the completely “hands-off” approach that can be utilized, and the reduced need for operator interaction in validating the composition of packaged and filled pharmaceuticals.

Various background art systems are known that can utilize the unique chemical signatures of known pharmaceuticals to verify the accuracy of the filled prescription through an NIR spectroscopic or other chemical analysis technique. Such a system is shown in U.S. Published Patent Application 2003/0174326, published Sep. 18, 2003. This application discloses a system utilizing a spectrometer to analyze dispensed prescriptions in which an open prescription vial which has been filled with the desired pharmaceutical is placed under the spectrometer, and a reading is taken of the top layer of medication in the prescription vial. The problem with this system is that only a small sampling of the dosage units of the pharmaceutical contained in the vials are analyzed for authenticity and accuracy by the spectrometer (i.e., only those dosage units at the top of the vial). It is possible that erroneous or counterfeit dosage units could be contained in the vial and not be visible to the spectrometer. In this system, it is possible for the vials to be contaminated with pharmaceuticals that are not an intended part of the dispensed prescription.

It is therefore an object of this invention to provide an improvement on known background art spectroscopic verification systems which will eliminate the problem of sporadic chemical sampling and which will provide a verification of each dosage unit in any given container or prescription vial.

### SUMMARY OF THE INVENTION

The preferred embodiment of the invention provides for a spectrometer which is integrated with an automated counting and dispensing device to allow for the chemical analysis of each dosage unit that is counted into a given container or prescription vial. The advantage of this embodiment is that the counting and chemical verification happen simultaneously, and the identity of each dosage unit is positively verified as its chemical and physical properties are expressed in a vibrational or electronic spectrum of the dosage unit.

The system comprises a vibrational or electronic spectrometer integrated with the automated counting and dispensing device such as to be able to sample each pharmaceutical dosage unit, and a control and interface module. The control and interface module is responsible for sending instructions to and reading data from the spectrometer, for analyzing the data read from the spectrometer, for providing a calibration facility for calibrating the unit to recognize various types of dosage units for the various types of pharmaceuticals and for interfacing to the control system of the automated dispensing device. The system also includes a database containing product quality models for the characterization of the spectral signatures of the various types of pharmaceuticals which the system will be expected to identify.

In operation, the type of pharmaceutical to be dispensed is identified to the system, and a mathematical product quality model defining the desired spectral signature is retrieved from the database. Instructions are sent to the spectrometer to set the parameters for data collection, and data collection is performed for each dosage unit. Data collection parameters may include integration time, spectral region, resolution, source intensity, or other parameters relevant to acquisition of spectral data. The spectroscopic data is read from the spectrometer and processed by the product quality model for the particular pharmaceutical, and the dosage unit is either verified or flagged as not matching. The process is repeated for each dosage unit. Preferably, another embodiment of this invention provides a system wherein the process is repeated for each dosage unit that is being prepared to exit the automated dispensing apparatus before the dosage unit enters a container or prescription vial.

The advantage of this methodology over the background art is that each dosage unit being dispensed into a container or a prescription vial is individually verified as being the correct pharmaceutical and the correct dosage, as opposed to only sampling the top layer of the dosage units dispensed into a prescription vial and wherein it must be assumed that the dosage units that are situated under the top layer in the vial are the same. The background art methodology verifies only that a limited number of dosage units making up a dispensed prescription were filled correctly and does not verify that every dosage unit dispensed is correct.

As will become apparent to those skilled in the art, numerous other embodiments and aspects will become evident hereinafter from the following descriptions and claims.

### BRIEF DESCRIPTION OF THE DRAWINGS

FIG. 1 is a schematic drawing of a typical background art counting and dispensing unit for pharmaceutical dosage units.

FIG. 2 shows the background art counting and dispensing unit of FIG. 1 having elements of the present invention integrated therewith.

FIG. 3 shows the system of the present invention integrated with the background art dispensing and counting unit.

FIG. 4 is a schematic representation of the system of the present invention showing data flow between the various components of the background art elements and the elements of the present invention.

FIG. 5 is a flow chart showing the functionality of the components of the invention and their interaction with the existing background art systems.

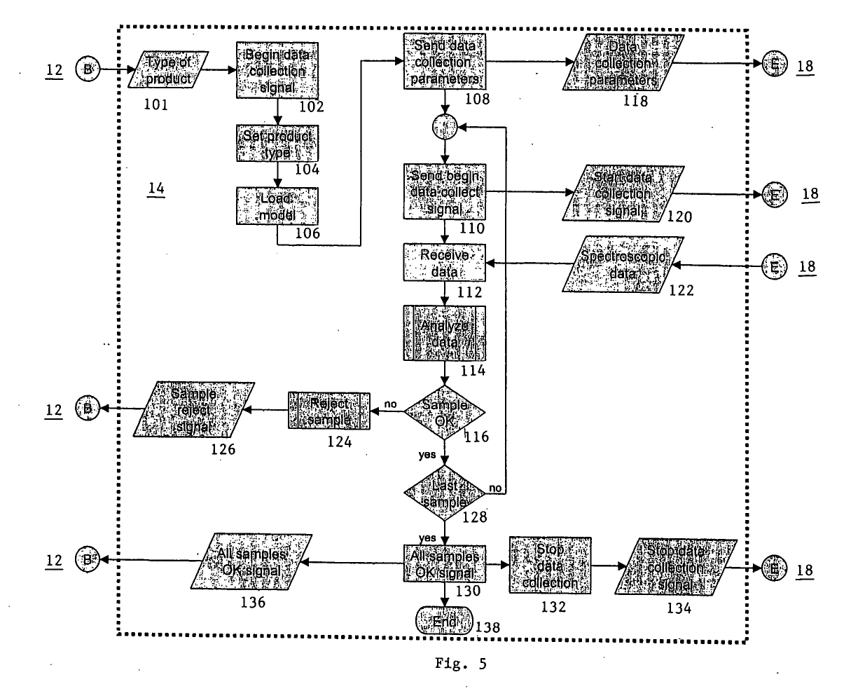

### DETAILED DESCRIPTION OF THE INVENTION

Approximately 90% of the most commonly prescribed and dispensed solid-dosage pharmaceuticals can be identified through an NIR or other spectroscopic technique with 100% accuracy. By comparing the “spectral signature” of a dispensed or filled prescription to an electronic database containing reference spectral signatures of known formulations, there can be near 100% assurance that a dispensed drug is correct in both type and concentration. The current invention provides the facility for the analyzing of each dosage unit at the point where it is dispensed from the automated counting device, such that each dosage unit is analyzed in a reproducible position, thereby providing consistent results from dosage unit to dosage unit. In the preferred embodiment of the invention, the analyzing of each dosage unit is effected at a point before it is dispensed from the automated counting device.

Note that while the application of the present invention is shown in a pharmacological context, this is only an exemplary application of the invention. The system may also be used in many other contexts, such as in agricultural, food industry and chemical applications. Additionally, the term “product unit” is used generically herein to signify the sample unit of a particular commodity being analyzed by the spectrometer. In the case of a pharmaceutical application, the product unit is a dosage unit of a pharmaceutical product.

With respect to the exemplary pharmaceutical application, there are uses for the invention in both the retail and wholesale markets. It is often desirable for wholesale distributors of pharmaceuticals to repackage dosage units into convenient sizes for shipment to, for example, pharmacies or other wholesale or retail outlets, while at the same time verifying the contents of the packages and detecting counterfeits. A counterfeit pharmaceutical will generally have a different spectral signature than the genuine pharmaceutical and can be easily detected. Likewise, pharmacies can use the device of the present invention to verify individual patient's prescriptions, thereby lowering their error rate and therefore possibly lowering their liability. Because many systems for providing basic dosage unit counting and inventory are already in existence, it is desirable that the components of the present invention be capable of being retrofitted onto existing equipment.

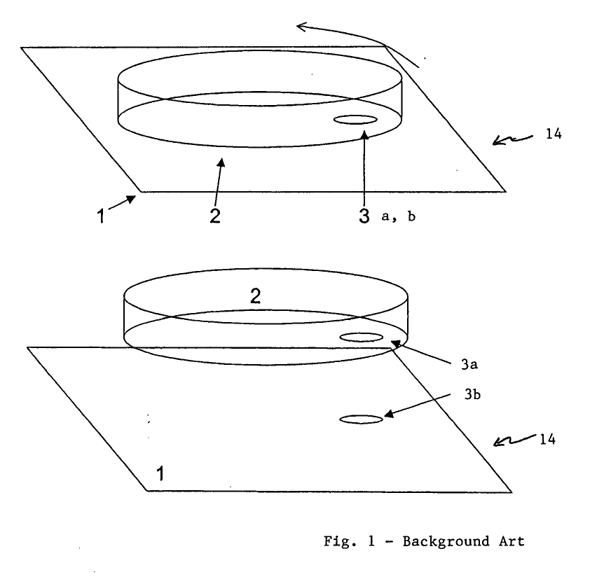

FIG. 1 shows a typical background art automated counting device 14 of the type used in a retail pharmacy for counting dosage units to be dispensed into the prescription vial that is ultimately presented to the customer. This typical background art automated counting device is often commonly referred to as a Baker Unit. In operation, tablet hopper 2, rotates until hole 3a defined therein aligns with hole 3b defined in floor 1 of automated counting device 14. When holes 3a and 3b align, one dosage unit of the pharmaceutical contained in tablet hopper 2 is dispensed therethrough.

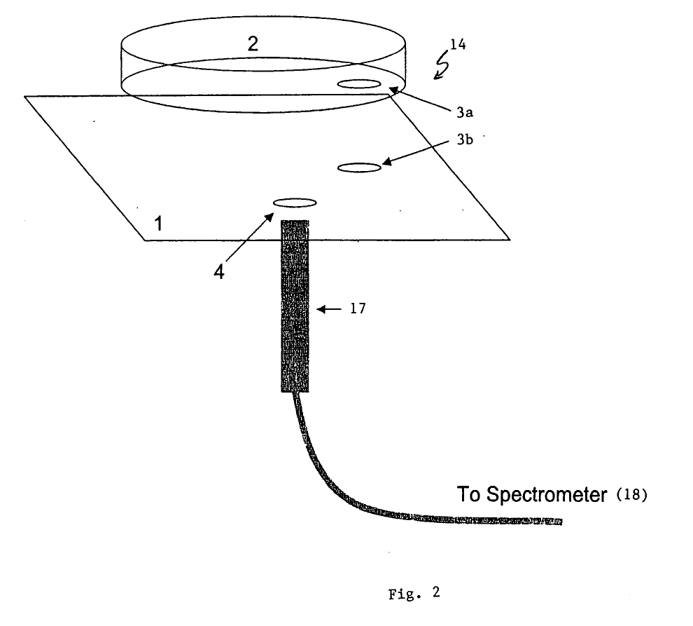

FIG. 2 shows background art automated counting device 14 with the present invention integrated therewith. A hole is defined in floor 1 of device 14 and is covered by window 4, preferably composed of quartz or sapphire. The fiber optic probe 17 of spectrometer 18 is mounted under floor 1 of the device such that sampling of individual dosage units may be performed through window 4. As tablet hopper 2 rotates in a counter-clockwise direction, the next tablet to be dispensed will first be analyzed by spectrometer 18 through window 4, and then will fall through holes 3b as hole 3a defined in the bottom of tablet hopper 2 first passes over window 4 and then hole 3b.

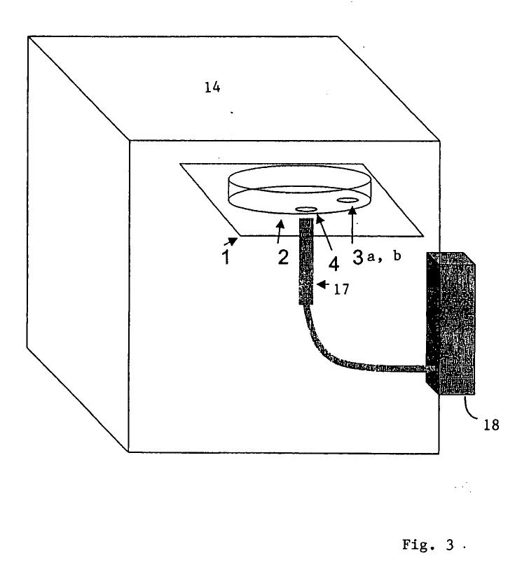

FIG. 3 shows spectrometer 18 mounted external to overall tablet counting system 7, with only fiber optic probe 17 of spectrometer 18 needing to be mounted internal to tablet counting system 18. In this manner, it is possible not only to manufacture new tablet counting systems 18 having the present invention integrated therein, but to retrofit the substantial already-installed base of background art tablet counting systems.

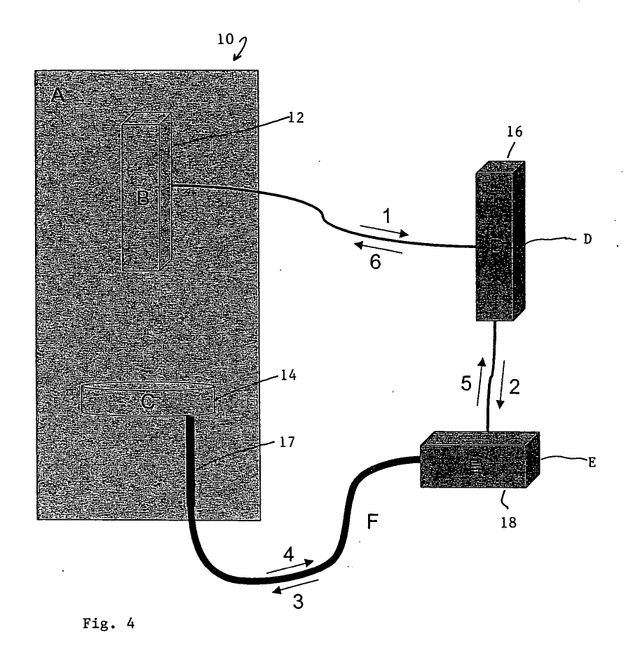

FIG. 4 shows an upper level schematic of the components of the present invention integrated with components of the background art system. The background art system has the components in box 10, namely, control system 12 and automated counting device 14, which may or may not be electronically linked with each other. The components of the present invention further include control and interface module 16 and spectrometer 18, which is integrated with automatic counting device 14. Spectrometer 18 is preferably a diode array spectrometer. An example of this type of spectrometer is model CDI 256 manufactured by Control Development Inc. of South Bend, Indiana, although many types of NIR instruments or other analytical techniques may be useful. Note also that in a pharmaceutical application, a vibrational spectrometer which can emit probing energy in the range of 800 nm to 2500 nm is preferred, while other applications for different types of products may require a different type of spectrometer, for example, an spectrometer that analyzes electronic spectra, such as an ultraviolet or visible spectrometer. Vibrational spectroscopy accesses the vibrational states of a molecule or molecules, while electronic spectroscopy accesses electronic states and transitions of a molecule or molecules.

In operation of the present invention, control system 12 initiates requests for verification to control and interface module 16 by sending a message which includes information regarding the particular pharmaceutical which is being dispensed, including the dosage and the count, and a request to initiate the analysis. Alternatively, this information could be directly entered into control and interface module 16 by the user, through a local user interface. Control and interface module 16 sends a message to spectrometer 18 which includes the paramaters for the collection of the data from that particular sample and request to begin analyzing. Spectrometer 18 will send interrogation energy 3 out to individual dosage units which are being dispensed from automated counting device 14 and collects energy 4 after interaction with the dosage units, which represents the spectral signature of the materials in the sample. Spectrometer 18 then transduces the collected energy 4 and sends spectroscopic data 5 to control and interface module 16.

Control and interface module 16 compares the spectral signature collected by spectrometer 18 with the reference spectral signature for the particular pharmaceutical being dispensed, using a product quality model for that product, and determines if there is a match. A match requires that product quality specifications for that product, as defined in the product quality model, are met. Control and interface module 16 then sends status message 6 back to control system 12 where the status is displayed to the user as either a successful verification or an error condition which would indicate that one or more dosage units being dispensed by automated counting device 14 did not have the expected spectral signature. This would indicate, such as for example but not limited to, an erroneous dispensing of the pharmaceutical dosage unit or units, a contaminated supply of the pharmaceutical dosage unit or units, or a counterfeit dosage unit or units.

FIG. 2 shows a flow chart of the top level functions of control and interface module 16. At box 102, a product information 101 is received from control system 12. As previously stated, product information 101 could also be supplied through a local user interface, in the absence of control system 12. Product information 101 would include a request for verification, and at least an identification of the pharmaceutical dosage unit being dispensed and the concentration and count of the dosage unit or units. At box 104, the product type is internally set and at box 106, the model for the particular type of pharmaceutical dosage unit is retrieved and loaded, based on the product information 101. At box 108, the data collection paramaters 118 are sent to spectrometer 18. Data collection parameters are associated with the product information 101. It is possible that different products will require different data collection parameters, therefore, these parameters are determined as part of the model building process, described herein.

At box 110, a signal to begin the data collection 120 is sent to spectrometer 18 and, at 112, spectroscopic data 122 is received from spectrometer 18. At box 114, the analysis of the data is undertaken by comparing the received data 122 with the model which was loaded in box 106.

To determine if any given dosage unit matches the reference product quality model, a principle component analysis is undertaken which takes into account spectral variance which may be encountered with individual samples. Any one of a number of well known data analysis methods may be used to determine a positive match, such as Soft Independent Modeling of Class Analogies (SIMCA) with principle component analysis.

At box 116, if the sample is not verified (i.e., spectroscopic data 122 does not match model loaded at 106), the dosage unit is rejected at 124 and a sample reject signal 126 is generated and sent to control system 12, or, alternatively, the local user interface. If the received spectroscopic data 122 and the model loaded at box 106 match, processing proceeds to box 128 where its determined if there are more dosage units to analyze. If there are more dosage units to analyze, then control is returned to box 110 where the start data collection signal 120 is sent to spectrometer 18.

If all of the dosage unit samples have been analyzed, it is determined in box 130 if all of the samples have been successfully matched with the loaded model. If all dosage units successfully match, an “all samples OK” signal 136 is sent to control system 12, or, alternatively, to the local user interface. In box 132 data collection is stopped by sending a stop data collection signal 134 to spectrometer 18 and the program is ended at box 138.

At this point, for example, further processing of the dosage units making up a given prescription proceeds in the manner, according to the background art methodologies as known by those skilled in the art.

The control and interface module 14, in the preferred embodiment, may be implemented in software running on a typical personal-type computer, or on any other equivalent computing and processing device. The database of product quality models will preferably be kept in a database on local disk, which may be updated through secure means, such as by secured internet update or through the distribution of update diskettes or CD-ROMS. Alternatively, the reference models could be accessed from a secure database accessible over the internet. Additionally, it is possible that the functions shown in box 14 in FIG. 2 could be implemented with multiple computers, for example, the interface with spectrometer 18 may be handled by a dedicated computing unit, while the data analysis and user interface functions may be performed by another computer. Many possible configurations are possible, and the invention is not meant to be limited by the physical manifestation of the system.

The creation of the reference product quality models is the result of sampling many dosage units of the desired pharmaceutical. Differences in manufacturing plants, manufacturing techniques, and raw materials must be taken into account when creating the model to avoid having legitimate samples of the pharmaceutical flagged as being non-compliant with the reference product quality model. Variations can occur when various samples of said product unit are manufactured over different seasons of the year, manufactured with unique tablet presses or other unique processing equipment, manufactured using unique raw materials or raw materials from unique suppliers, manufactured on equipment that provides a unique process signature due to wear, manufactured with unique process equipment operators, or manufactured at different manufacturing facilities.

As a result, each product quality model will preferably be created as the result of the sampling of several hundred samples from different manufacturing facilities. Models may be created using commercially-available software, such as Matlab™ 7, manufactured by The Mathworks, Inc. of Natick, Massachusetts and PLS_Toolbox 3, manufactured by Eigenvector Research, Inc. of Manson, Wash.

The mathematical modeling will involve the creation of mathematical models (one for each product to be tested with the system) that define a relationship between the near-infrared spectra (or other spectral signature) of the product and the important product quality attributes. Numerous samples of the product will be first analyzed by the near-infrared (or other) method before using the generated spectra to identify the extremes of spectral characteristics that are typical of spectra that represent a product unit of acceptable quality.

Numerous algorithms exist for practicing the type of qualitative discriminant analysis that will likely be used for detecting product identity and quality. For example, one such algorithm is SIMCA. SIMCA uses principal component analysis (a type of factor analysis) of near infrared spectra for the construction of mathematical models for each set of samples to be analyzed. The class models depend on the principal-axes that are retained. The residual variance of a test spectrum fitted to a class model, representing the population of product that is considered to be of good quality, is divided by the total variance of the samples within that class to give a variance ratio. The variance ratio is used to estimate the probability of a test sample belonging to the same population from which the class model was derived, that is, having the properties of a sample that is appropriate in terms of identity and quality.

The qualitative models that are used to predict product quality attributes for various products must be created using samples that contain all of the potential sources of variation that will likely be encountered during product testing. As an example, the “process signature” that arises from the manufacture of product units in unique production facilities can cause even chemically identical products (i.e., the same formulation from the same manufacturer) to appear spectrally different, due to unique physical differences. Model building efforts must allow for the inclusion of spectra that arise from product manufactured in all manufacturing sites, if product from those sites will ultimately be tested using the model.

Spectral “preprocessing” algorithms will be applied to product spectra prior to the determination of a sample's identity and quality in the product quality testing system. The preprocessing is used for the purpose of reducing the confounding spectral characteristics that result from physical variations in samples that are a result of the manufacturing process or other sources. Such preprocessing methods are valuable for reducing or eliminating the type of baseline shifting that is common with NIR spectroscopy, and due to those sources just mentioned. Preprocessing algorithms typically include first- or second-derivatives, multiplicative scatter correction (MSC), standard normal variant (SNV) and other routines well known by those skilled in the art.

Although the present invention has been described and illustrated in the above description and drawings, it is understood that the verification of pharmaceutical dosage units is an application that is exemplary in nature and that numerous other applications and use in other industries for the verification of a variety of other products is contemplated to be within the scope of this invention. Additionally, changes, variations and modifications in the implementations of the invention can be made by those skilled in the art without departing from the true spirit and scope of the invention. The invention, therefore, is not to be restricted, except by the following claims and their equivalents.

1. A method for verifying the identity of a product unit comprising the steps of:
analyzing each product unit to obtain a signature;
comparing said signature from each product unit to a known signature; and
indicating if the signature of any analyzed product unit did not match said known signature.

2. The method of claim 1 wherein said signature for each product unit is a spectral signature obtained by analysis of said product unit with a spectrometer.

3. The method of claim 2 wherein said spectrometer provides a vibrational or electronic spectrum of said analyzed product units.

4. The method of claim 3 wherein said product unit is a pharmaceutical dosage unit.

5. The method of claim 4 wherein said pharmaceutical dosage unit is dispensed into a prescription vial after said dosage unit is analyzed by said spectrometer.

6. The method of claim 1 wherein said known signature is a reference mathematical model.

7. The method of claim 6 wherein said mathematical model is based on the sampling of a plurality of product units having known variations.

8. The method of claim 7 wherein said known variations are due to the manufacturing process of said product unit.

9. The method of claim 8 wherein said comparing step utilizes a principle component analysis which takes into account spectral variance.

10. The method of claim 1 further comprising the step of providing a database of known signatures and a product quality model for each type of product unit.

11. An apparatus for dispensing one or more product units into a container comprising:
a product unit counting device;
an analyzing device integrated with said product unit counting device, such that each product unit dispensed from said product unit counting device is analyzed by said analyzing device; and
a control device for controlling said analyzing device.

12. The apparatus of claim 11 wherein said control device performs the functions of:
sending a signal to said analyzing device to commence analysis of said product unit;
receiving data from said analyzing device representing an analyzed signature associated with said product unit; and
sending a signal to said analyzing device to cease analysis of said product unit.

13. The apparatus of claim 12 wherein said control device performs the functions of:
receiving information regarding the expected identity of said product units;
retrieving a signature known to be associated with said identified product units;
receiving an analyzed signature obtained from each of said product units;
comparing said known signature with each of said analyzed signatures to verify a match therebetween within a certain degree of confidence; and
indicating if the analyzed signature for any of said product units did not match said known signature.

14. The apparatus of claim 13 further comprising a database from which said signature known to be associated with said identified product units is retrieved.

15. The apparatus of claim 14 wherein said analysis device is a spectrometer for obtaining vibrational or electronic spectra and wherein said analyzed signature and said known signature are spectra.

16. The apparatus of claim 15 wherein said known signature is a reference mathematical model of a plurality of spectra from a plurality of samples of said product unit.

17. The apparatus of claim 16 wherein said mathematical model is based on the sampling of a plurality of product unit samples having known variations.

18. The apparatus of claim 17 wherein said known variations are due to the variations in the manufacturing process of said product unit.

19. The apparatus of claim 18 wherein said comparing step utilizes a principle component analysis which takes into account spectral variance.

20. The apparatus of claim 11 further comprising a database of known signatures for each type of product unit.

21. The apparatus of claim 11 wherein said container is a prescription vial.

22. The apparatus of claim 11 wherein said product unit is a pharmaceutical dosage unit.

23. In an apparatus for counting and dispensing one or more product units into a container comprising a product unit counting device and a control therefore, an improvement comprising:
an analyzing device integrated with said product unit counting device, such that each product unit dispensed from said product unit counting device is analyzed by said analyzing device; and
a control device for controlling said analyzing device.

24. The improvement of claim 23 wherein said control device performs the functions of:
sending a signal to said analyzing device to commence analysis of said product unit;
receiving data from said analyzing device representing an analyzed signature associated with said product unit; and
sending a signal to said analyzing device to cease analysis of said product unit.

25. The improvement of claim 24 wherein said control device performs the functions of:
receiving information regarding the expected identity of said product units;
retrieving a signature known to be associated with said identified product units;
receiving an analyzed signature which is obtained from each of said product units;
comparing said known signature with each of said analyzed signatures to verify a match therebetween within a certain degree of confidence; and
indicating if the analyzed signature for any of said product units did not match said known signature.

26. The improvement of claim 25 further comprising a database from which said signature known to be associated with said identified product units is retrieved.

27. The improvement of claim 26 wherein said analyzing device is a vibrational or electronic spectrometer and wherein said analyzed signature and said known signature are spectra.

28. The improvement of claim 27 wherein said known signature is represented by a product quality model of a plurality of spectra from a plurality of samples of said product unit.

29. The improvement of claim 28 wherein said mathematical model is based on the sampling of a plurality of product unit samples having known variations.

30. The improvement of claim 29 wherein said known variations are due to the manufacturing process of said product unit.

31. The improvement of claim 30 wherein said comparing step utilizes a principle component analysis which takes into account spectral variance.

32. The improvement of claim 31 further comprising a database of known signatures for each type of product unit.

33. The improvement of claim 32 wherein said container is a prescription vial and further wherein said product unit is a pharmaceutical dosage unit.

34. A system for verifying the identify of a product unit comprising:
an analyzing device for analyzing each one of a plurality of product units to obtain a unique signature; and
a control component for controlling said analyzing device and for receiving said signature therefrom.

35. The system of claim 34 wherein said analyzing device is a spectrometer.

36. The system of claim 35 wherein said spectrometer is a vibrational or electronic spectrometer and wherein said analyzed signature is a spectrum.

37. The system of claim 34 wherein said control component is a computer having a data connection with said analyzing device.

38. The system of claim 34 further comprising an interface component.

39. The system of claim 34 further comprising a database containing known signatures for a plurality of known product units.

40. The system of claim 39 wherein said known signatures are mathematical product quality models of spectra obtained from a plurality of samples of each of said known product units having known variations.

41. The system of claim 40 wherein said control component performs a mathematical match between said analyzed signature and said known signature.

42. The system of claim 41 wherein said mathematical match utilizes a principle component analysis which takes into account spectral variance.
